(19) United States
(12) Patent Application Publication
(10) Pub. No.: US 2017/0069406 A1
(43) Pub. Date: Mar. 9, 2017

(54) ESTER COMPOSITIONS FOR DIELECTRIC FLUIDS

(71) Applicant: M&I MATERIALS LIMITED, MANCHESTER (GB)

(72) Inventors: RUSSELL MARTIN, MANCHESTER (GB); FRANCINE EDWARDS, MANCHESTER (GB)

(21) Appl. No.: 15/255,308

(22) Filed: Sep. 2, 2016

(30) Foreign Application Priority Data
Sep. 4, 2015 (GB) 1515729.0

(51) Int. Cl. H01B 3/20

(52) U.S. Cl. CPC H01B 3/20

(57) ABSTRACT

The present invention relates to synthetic ester compositions, and to dielectric fluid compositions containing them, as well as to methods of manufacturing the ester compositions and dielectric fluid compositions containing them, and to an electrical apparatus containing the dielectric fluid compositions.

### RELATED APPLICATIONS

The present application claims priority from UK 1515729.0, filed on Sep. 4, 2015, which is incorporated herein by reference.

### TECHNICAL FIELD

The present invention relates to synthetic ester compositions, and to dielectric fluid compositions containing them, as well as to methods of manufacturing the ester compositions and dielectric fluid compositions containing them, and to an electrical apparatus containing the dielectric fluid compositions.

### BACKGROUND

The use of dielectric fluids in electrical apparatus such as transformers is well known. Dielectric fluids are used throughout the world in transformers to provide electrical insulation, provide cooling and prevent excessive temperature rise within transformers, to suppress corona and arcing, and thus to prolong the lifetime of the transformer. Dielectric fluids known for such use include mineral oil based fluids, natural ester based fluids and synthetic ester based fluids. Known synthetic esters include those produced from the reaction of an alcohol with one or more carboxylic acids. Dielectric fluids based on such synthetic esters have a number of advantages over mineral oil based fluids, but there remains a need for synthetic esters having improved properties, particularly in their pour point, flash point and viscosity properties.

There is therefore always a need and a desire for an ester composition that is able to exhibit improved properties over the existing compositions which enable them to perform more effectively as a dielectric fluid, and avoiding the problems experienced with existing compositions, and which can make the manufacture of the compositions more economical.

### SUMMARY

Therefore, in accordance with a first aspect of the invention, there is provided an ester composition, wherein the ester composition comprises a plurality of esters derived from a reaction of:
i) one or more polyols, wherein the one or more polyols are each independently a straight chain or branched C₂-C₈ polyol; and
ii) first, second and third carboxylic acids, wherein the first, second and third carboxylic acids are each independently a straight chain or branched C₄-C₁₂ carboxylic acid.

### DETAILED DESCRIPTION

According to one embodiment of the invention, each of the one or more polyols may be a C₂, C₃, C₄, C₅, C₆, C₇, or C₈ polyol. Typically, each of the one or more polyols is selected from straight or branched C₂ to C₅ polyols, and may have a C₂ to C₃ backbone, with or without one or more hydrocarbon side groups. Where any of the polyols are branched, they typically have one or more C₁ or C₂ side groups, typically C₁. Typically, a branched C₅ polyol is used.

By way of non-limiting examples, the polyol may be selected from pentaerythritol, neopentyl glycol (NPG), glycerol, butane diol, ethylene glycol and propylene glycol. More typically, only one polyol is used; the polyol typically comprises one of pentaerythritol or NPG, more typically the polyol comprises pentaerythritol, or the polyol consists of pentaerythritol only.

According to another embodiment of the invention, the first, second and third carboxylic acids are typically each independently selected from straight chain or branched C₄, C₅, C₆, C₇, C₈, C₉, C₁₀, C₁₁ and C₁₂ carboxylic acids. According to one embodiment of the invention, the polyol may react with one or more further carboxylic acids which is or are different to the first, second and third carboxylic acids. Alternatively, according to another embodiment of the invention only the first, second and third carboxylic acids are used.

According to one embodiment, the first carboxylic acid is a C₇, C₈, or C₉ carboxylic acid. The first acid may be a C₈ acid, such as a branched C₈ acid. The first acid may have a C₆ backbone and a side group, which may be a C₂ side group, which may be located at the C2-position. The first acid may be, for example, 2-ethylhexanoic acid (2EHA).

According to one embodiment, the second carboxylic acid is a straight chain or branched C₆, C₇, or C₈ carboxylic acid, such as a C₇ acid, still more typically a straight chain linear C₇ acid, i.e. n-heptanoic acid.

According to one embodiment, the third carboxylic acid is a straight chain or branched C₈, C₉, or C₁₀ carboxylic acid, such as a C₉ acid, still more typically a straight chain linear C₉ acid, i.e. n-nonanoic acid.

According to one embodiment, the ester composition comprises esters formed from the reactions of a polyol with (i) a branched C₈ carboxylic acid as the first carboxylic acid; (ii) a linear C₇ carboxylic acid as the second carboxylic acid and (iii) a linear C₉ carboxylic acid as the third carboxylic acid.

According to one embodiment, the polyol comprises or consists of pentaerythritol, the first carboxylic acid is 2EHA, the second carboxylic acid is n-heptanoic acid and the third carboxylic acid is n-nonanoic acid.

According to one embodiment, the reaction acid mixture has a molar amount of about 40-85% of the first carboxylic acid (such as 2EHA) and about 5-60% of the second and third carboxylic acids combined (such as n-C₇ and n-C₉ carboxylic acids), more typically about 45-60% of the first carboxylic acid and about 10-55% of the second and third carboxylic acids together, more typically about 50% of the first carboxylic acid and about 50% of the second and third carboxylic acids together.

The resulting product from this reaction of one or more polyols and three carboxylic acids is not a pure substance and comprises a mixture of a number of possible ester structures. This ester mixture arises as a natural consequence of the reaction process. For example, pentaerythritol contains four alcohol functional groups, so the reaction of pentaerythritol with three acids (such as 2EHA, a C₇ acid and a C₉ acid) would result in many different tetra-ester structures containing different combinations of the functional groups from the three different acids.

The ester composition may comprise small amounts of unreacted alcohol and/or acids as impurities. Typically, the ester composition is substantially free of alcohol and/or acids.

The ester composition of the invention has dielectric properties, and is suitable for use as a dielectric fluid.

The ester composition of the invention typically has a viscosity of 35 cP or less when measured using a Brookfield DV-I Prime Viscometer at 40° C.; more typically it has a viscosity of 33 cP or less at 40° C.; more typically it has a viscosity of 30 cP or less at 40° C.; still more typically it has a viscosity of 28 cP or less at 40° C. Suitably, said viscosity comprises dynamic viscosity.

The ester composition of the invention typically has a pour point of minus 20° C. or less; more typically it has a pour point of minus 30° C. or less; more typically it has a pour point of minus 40° C. or less; still more typically it has a pour point of minus 50° C. or less.

The ester composition of the invention typically has a measured pour point of minus 50° C. to minus 62° C., or even lower, when the pour point is measured according to the standard of ISO 3016.

The ester composition of the invention typically has a COC (Cleveland open cup) fire point of 280° C. or higher when measured according to the standard of ISO 2592; more typically it has a COC fire point of 300° C. or higher; still more typically it has a COC fire point of 310° C. or higher.

According to a second aspect of the invention, there is provided a dielectric fluid composition comprising:

(I) an ester composition, wherein the ester composition comprises a plurality of esters derived from a reaction of:
i) one or more polyols, wherein the one or more polyols are each independently a straight chain or branched C₂-C₈ polyol; and
ii) first, second and third carboxylic acids, wherein the first, second and third carboxylic acids are each independently a straight chain or branched C₄-C₁₂ carboxylic acid; and

(II) one or more additives.

The one or more polyols in (i) and the first, second and third carboxylic acids in (ii) which may be used in this dielectric fluid composition are the same as those defined hereinabove in relation to the ester composition of the first aspect of the invention.

The additives are typically selected from antioxidants, metal deactivators and pour point depressants, and combinations thereof.

Typically, the dielectric fluid composition comprises the ester composition (I) in an amount of at least 95% by weight of the dielectric fluid composition. Suitably, the dielectric fluid composition comprises the ester composition (I) in an amount of at least 96% by weight of the composition, for example in an amount of at least: 97%, 98% or 99% by weight of the composition. Typically, the dielectric fluid composition comprises the ester composition (I) in an amount of at least 99.5% by weight of the composition.

Typically, the dielectric fluid composition comprises the additives (II) in the following amounts:
one or more antioxidants in a total amount of about 0.0001% to about 1% by weight of the composition; and/or
one or more metal deactivators in a total amount of about 0.0001% to about 1% by weight of the composition; and/or
one or more pour point depressants in a total amount of 0% to about 1% by weight of the composition.

Combinations of any two or more of these additives may be used, as desired.

Typically, the dielectric fluid composition comprises an antioxidant in an amount of at least about 0.0001% by weight of the composition, more typically in an amount of at least about 0.001%, at least about 0.01%, at least about 0.1%, at least about 0.25% by weight of the composition, for example in an amount of about 0.25% by weight of the composition.

The antioxidant may comprise a phenolic antioxidant, such as a sterically hindered phenolic antioxidant. The antioxidant may comprise butylated hydroxytoluene (BHT) and/or butylated hydroxyanisole (BHA), or may be a chemically similar type of sterically hindered phenolic antioxidant.

Typically, the dielectric fluid composition comprises a metal deactivator in an amount of at least about 0.0001% by weight of the composition; more typically in an amount of at least about 0.001%, at least about 0.002%, or at least about 0.005% by weight of the composition, for example in an amount of about 0.005% by weight of the composition. Typically, the metal deactivator comprises a tolutriazole derivative, which may comprise Irgamet 39™, which is a tolutriazole derivative commercially available from BASF.

Suitably, the dielectric fluid composition comprises one or more additives (II) selected from antioxidants and metal deactivators.

The dielectric fluid composition may be substantially or completely free from pour point depressant. Alternatively, the dielectric fluid composition may comprise a pour point depressant. Typically, the ester composition (I) is suitable for use as a dielectric fluid without the need to be combined with a pour point depressant.

Typically, the dielectric fluid composition comprises an ester composition (I) and additives (II) in a combined amount of at least about 95% by weight of the composition, typically at least about 99% by weight of the composition, more typically in a combined amount of at least about 99.9% by weight of the composition. Typically, the dielectric fluid composition consists only of the ester composition (I) and additives (II).

Typically, the dielectric fluid composition comprises an ester composition, an antioxidant and a metal deactivator in a combined amount of at least 95% by weight of the composition, more typically in a combined amount of at least 99% by weight of the composition, more typically in a combined amount of at least 99.9% by weight of the composition. Typically, the dielectric fluid composition consists of an ester composition, an antioxidant and a metal deactivator.

The dielectric fluid composition may comprise minor or trace amounts of unreacted alcohol and/or acids as impurities. Suitably, the dielectric fluid composition is substantially free of alcohol and/or acids.

The dielectric fluid composition of the invention typically has a viscosity of 35 cP or less when measured using a Brookfield DV-I Prime Viscometer at 40° C.; more typically it has a viscosity of 33 cP or less at 40° C.; more typically it has a viscosity of 30 cP or less at 40° C.; still more typically it has a viscosity of 28 cP or less at 40° C. Suitably, said viscosity comprises dynamic viscosity.

The dielectric fluid composition of the invention typically has a pour point of minus 20° C. or less; more typically it has a pour point of minus 30° C. or less; more typically it has a pour point of minus 40° C. or less; still more typically it has a pour point of minus 50° C. or less.

The dielectric fluid composition of the invention typically has a measured pour point of minus 50° C. to minus 62° C., or even lower, when the pour point is measured according to the standard of ISO 3016.

The dielectric fluid composition of the invention typically has a COC (Cleveland open cup) fire point of 280° C. or higher when measured according to the standard of ISO 2592; more typically it has a COC fire point of 300° C. or higher; still more typically it has a COC fire point of 310° C. or higher.

According to a third aspect of the invention, there is provided a method of manufacturing an ester composition, wherein the method comprises forming a plurality of esters by reacting:
i) one or more polyols, wherein the one or more polyols are each independently a straight chain or branched C₂-C₈ polyol; and
ii) first, second and third carboxylic acids, wherein the first, second and third carboxylic acids are each independently a straight chain or branched C₄-C₁₂ carboxylic acid.

The one or more polyols in (i) and the first, second and third carboxylic acids in (ii) which may be used in this dielectric fluid composition are the same as those defined hereinabove in relation to the ester composition of the first aspect of the invention.

Typically, the method comprises reacting the polyol with the carboxylic acids wherein the acids are in excess by an amount of at least 10 molar %; more typically in an excess of at least 20 molar %, for example an excess of 30 molar %.

Typically, the method comprises refluxing a mixture of the one or more polyols and the first, second and third carboxylic acids. The refluxing may be carried out for a period of between about 3 and 9 hours, and the reflux temperature may be between about 245° C. and 255° C., for example between 248° C. and 252° C. The reaction mixture begins to reflux at approximately 200° C. Typically, the method comprises refluxing under a nitrogen atmosphere.

Typically, the method comprises removing water as it is formed. Any excess acid may be removed following the reflux stage. If necessary, the reaction mixture may be adjusted to neutral pH—i.e. between about 6-8—following the reflux stage. Typically, the method comprises treating the ester composition to obtain this neutral pH.

Typically, the method comprises adding alumina and/or Fuller's earth powders and/or an antioxidant. The ester composition may be filtered during the method. The antioxidant may be added with heating, typically prior to filtering.

According to a fourth embodiment of the present invention, there is provided a method of manufacturing a dielectric fluid composition comprising an ester composition, wherein the method comprises combining an ester composition with one or more additives, wherein the ester composition comprises a plurality of esters derived from the reaction of:
i) one or more polyols, wherein the one or more polyols are each independently a straight chain or branched C₂-C₈ polyol; and
ii) first, second and third carboxylic acids, wherein the first, second and third carboxylic acids are each independently a straight chain or branched C₄-C₁₂ carboxylic acid.

The one or more polyols in (i) and the first, second and third carboxylic acids in (ii) which may be used in this dielectric fluid composition are the same as those defined hereinabove in relation to the ester composition of the first aspect of the invention.

The one or more additives may be selected from antioxidants, metal deactivators and pour point depressants, and combinations thereof. The various additives and their respective amounts are also already defined hereinabove in relation to the dielectric fluid composition of the second aspect of the invention.

Typically, the method comprises adding an antioxidant, which may be added with or without heating. The antioxidant may also be added prior to, or after, any filtering of the ester composition.

If a metal deactivator is added as an additive, the metal deactivator may be added prior to, or after, any filtering of the ester composition.

The dielectric fluid may be used in an electrical apparatus. The electrical apparatus may be a transformer, such as a high voltage transformer. Also provided within the present invention is an electrical apparatus containing the dielectric fluid composition defined herein according to the second aspect of the invention.

According to another embodiment of the present invention, there is provided the use of an ester composition as defined hereinabove either in, or as, a dielectric fluid.

The present invention will now be illustrated by way of the following example, which are intended to be exemplary only, and in no way limiting upon the scope of the invention.

### Example 1

An ester composition suitable for use as a dielectric fluid was prepared by forming esters by reacting pentaerythritol with a mixture of n-heptanoic acid (C₇), n-nonanoic acid (C₉), and 2-ethylhexanoic acid. Approximately 860 g of ester composition was prepared according to the following method:

200 g of pentaerythritol was combined with 397.8 g of n-heptanoic acid, 127.4 g of n-nonanoic acid, and 594.2 g of 2-ethylhexanoic acid. The amounts of acids and alcohols were selected such that the acid mixture was present in a 36% molar excess relative to the alcohol and such that the acid were present relative to one another in the molar percentages set out in Table 1 below.

TABLE 1

| Acid | Molar % |
|---|---|
| C₇ | 38 |
| C₉ | 10 |
| 2-EHA | 52 |

Esters were then prepared by refluxing pentaerythritol with the acid mixture at between 248-252° C. under a nitrogen atmosphere for 5 hours to produce an ester composition. Water was removed as it was formed using a Dean-Stark apparatus.

Following completion of the reflux stage, excess acid was removed by vacuum distillation, and the acid value, hydroxyl value and colour of the ester composition were determined. The results are presented in Table 3 below.

The ester composition was then processed further to prepare a dielectric fluid composition.

The ester composition was then stirred at 80° C. for one hour in the presence of Alumina in such an amount as was required to neutralise the reaction mixture to remove any residual acid, as well as Fullers' earth powders F160 and F115FF to clean the sample, and sterically hindered phenolic antioxidant. The composition was then filtered.

A tolutriazole derivative metal deactivator, Irgamet® 39, was added to the composition.

The composition was then degassed for approximately 30 minutes until the moisture content of the composition was below 80 ppm.

Electrical and physical testing was performed on the composition according to the test methods given in Table 2 below. The results are presented in Table 3.

TABLE 2

| Property | Test Method |
|---|---|
| Water content | IEC 60814 |
| Acid Value | Modified IEC 62021-2 |
| Hydroxyl value | IR spectrometer |
| Colour | ISO 2211 |
| Tan delta at 90° C. | IEC 60247 |
| VR at 90° C. | IEC 60247 |
| Breakdown voltage | IEC 60156 |
| Viscosity at 40° C. | Brookfield DV-I Prime |
| | Viscometer |
| Density at 20° C. | ISO 3675 |
| COC fire point | ISO 2592 |
| PMCC flash point | ISO 2719 |
| Pour point | Modified ISO 3016 |

TABLE 3

| Physical and electrical | |
|---|---|
| properties | Value |
| Water content (ppm) | 50 |
| Acid Value (mgKOH/g) | 0.022 |
| Hydroxyl (mgKOH/g) | 0.5 |
| Colour (HU) | 57 |
| Tan delta at 90° C. | 0.008 |
| VR at 90° C. (GΩm) | 32.6 |
| Breakdown (kV) | 93.5 |
| Viscosity at 40° C. (cP) | 26.4 |
| Density at 20° C. (g/cm³) | 0.973 |
| COC Fire point (° C.) | 312 |
| PMCC Flash point (° C.) | 268 |
| Pour point (° C.) | −56 |

As can be seen from the above, the dielectric composition of Example 1 has physical and electrical properties rendering it entirely suitable for use as a dielectric fluid and comparable with the properties of commercially available products.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

It is of course to be understood that the present invention is not intended to be restricted to the foregoing specific embodiments, which are described by way of example only. The invention extends to any novel feature, or combination of features, disclosed in this specification (including any accompanying claims, abstract and drawings), or to any novel one, or any novel combination, of the steps of any method or process so disclosed.

1. An ester composition, wherein the ester composition comprises a plurality of esters derived from a reaction of:
i) one or more polyols, wherein the one or more polyols are each independently a straight chain or branched C₂-C₈ polyol; and
ii) first, second and third carboxylic acids, wherein the first, second and third carboxylic acids are each independently a straight chain or branched C₄-C₁₂ carboxylic acid.

2. An ester composition according to claim 1, wherein the one or more polyols are each independently selected from straight or branched C₂ to C₆ polyols.

3. An ester composition according to claim 2, wherein the one or more polyols each independently have a C₂ to C₃ backbone and one or more C₁ or C₂ hydrocarbon side groups.

4. An ester composition according to claim 1, wherein the one or more polyols comprise pentaerythritol, neopentyl glycol (NPG), glycerol, butane diol, ethylene glycol or propylene glycol, or combinations of any thereof.

5. An ester composition according to claim 1, wherein only one polyol is used.

6. An ester composition according to claim 5, wherein the polyol comprises pentaerythritol.

7. An ester composition according to claim 1, wherein the first carboxylic acid comprises a C₇, C₈, or C₉ acid.

8. An ester composition according to claim 7, wherein the first carboxylic acid comprises a branched C₈ acid.

9. An ester composition according to claim 7, wherein the first carboxylic acid comprises 2-ethylhexanoic acid.

10. An ester composition according to claim 1, wherein the second carboxylic acid is selected from a straight chain or branched C₆, C₇, or C₈ acid.

11. An ester composition according to claim 10, wherein the second carboxylic acid is a C₇ acid.

12. An ester composition according to claim 11, wherein the second carboxylic acid is n-heptanoic acid.

13. An ester composition according to claim 1, wherein the third carboxylic acid is selected from a straight chain or branched C₈, C₉, or C₁₀ acid.

14. An ester composition according to claim 13, wherein the third carboxylic acid is a C₉ acid.

15. An ester composition according to claim 14, wherein the third carboxylic acid is n-nonanoic acid.

16. An ester composition according to claim 7, comprising a molar amount of about 40-85% of the first carboxylic acid and about 5-60% of the second and third carboxylic acids combined.

17. An ester composition according to claim 1, wherein the one or more polyols comprise pentaerythritol, the first carboxylic acid comprises 2-ethylhexanoic acid, the second carboxylic acid comprises n-heptanoic acid, and the third carboxylic acid comprises n-nonanoic acid.

18. A dielectric fluid composition comprising:
(I) an ester composition according to claim 1; and
(II) one or more additives.

19. A dielectric fluid composition according to claim 18, wherein the additives are selected from antioxidants, metal deactivators and pour point depressants, and combinations thereof.

20. A dielectric fluid composition according to claim 18, wherein the additives do not include a pour point depressant.

21. A dielectric fluid composition according to claim 18, wherein the dielectric fluid composition comprises the ester composition (I) and additives (II) in a combined amount of at least 99% by weight of the composition.

22. A dielectric fluid composition according to claim 18, wherein the dielectric fluid composition comprises an antioxidant in an amount of at least 0.0001% by weight of the composition and/or a metal deactivator in an amount of at least 0.0001% by weight of the composition.

23. A dielectric fluid according to claim 22, wherein the antioxidant comprises a sterically hindered phenolic antioxidant and/or wherein the metal deactivator comprises a tolutriazole derivative.

24. An electrical apparatus containing a dielectric fluid composition according to claim 18.

25. A method of manufacturing an ester composition according to claim 1, wherein the method comprises forming a plurality of esters by reacting:
(i) one or more polyols, wherein the one or more polyols are each independently a straight chain or branched C₂-C₈ polyol; and
(ii) first, second and third carboxylic acids, wherein the first, second and third carboxylic acids are each independently a straight chain or branched C₄-C₁₂ carboxylic acid.

26. A method of manufacturing a dielectric fluid composition comprising an ester composition according to claim 1, wherein the method comprises combining the ester composition with one or more additives.

27. A method according to claim 26, wherein the additives are selected from antioxidants, metal deactivators and pour point depressants, and combinations thereof.

28. A method according to claim 26, wherein the additives do not include a pour point depressant.

29. The use of an ester composition according to claim 1 as a dielectric fluid.
